(19) United States
(12) Patent Application Publication
(10) Pub. No.: US 2026/0106420 A1
(43) Pub. Date: Apr. 16, 2026

(54) SHIELDING TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Keisuke KANEMURA, Mie (JP)

(21) Appl. No.: 19/250,485

(22) Filed: Jun. 26, 2025

(30) Foreign Application Priority Data
Jun. 28, 2024 (JP) 2024-105014

(51) Int. Cl. H01R 24/40; H01R 103/00

(52) U.S. Cl. CPC H01R 24/40; H01R 2103/00

(57) ABSTRACT

In a shielding terminal, an inner conductor, a dielectric, and an outer conductor are disposed in this order from an inner side toward an outer side in a radial direction. The outer conductor includes a circumferential wall covering an outer circumferential surface of the dielectric. The circumferential wall includes an opening portion that extends radially through and a contact portion defined by the opening portion. The dielectric has a cavity extending along an axial direction and a hole portion extending in the radial direction from an outer circumferential surface of the dielectric to the cavity. The hole portion and the opening portion have a through-passage extending through in the radial direction at the same position in the axial direction and in the circumferential direction.

### CROSS-REFERENCE TO RELATED APPLICATIONS

This application is based on and claims priority from Japanese Patent Application No. 2024-105014, filed on Jun. 28, 2024, with the Japan Patent Office, the disclosure of which is incorporated herein in its entirety by reference.

### TECHNICAL FIELD

The present disclosure relates to a shielding terminal.

### BACKGROUND

JP 2022-022144 A discloses a shielding terminal as a connection device including an inner terminal (hereinafter referred to as an “inner conductor”), an outer terminal (hereinafter referred to as an “outer conductor”), and a dielectric located between the inner conductor and the outer conductor. The inner conductor is accommodated in the dielectric. The outer conductor surrounds the dielectric. FIG. 13 in JP 2022-022144 A shows a structure in which a longitudinal hole is formed in a distal end portion of the dielectric, a rectangular hole is formed in a distal end portion of the outer conductor, and the inner conductor is visible from the outside of the outer conductor through the rectangular hole and the longitudinal hole. This kind of shielding terminal is also described in WO 2023/072579.

### SUMMARY

In JP 2022-022144 A, it is possible to detect that the inner conductor is accommodated at a correct position in the dielectric by viewing the inner conductor through the longitudinal hole and the rectangular hole. However, a special process of punching the rectangular hole in the outer conductor is required, and there is room for improvement in terms of workability of the outer conductor.

Accordingly, an object of the present disclosure is to provide a shielding terminal enables detecting the accommodation state of an inner conductor in a dielectric without decreasing workability of an outer conductor.

A shielding terminal according to the present disclosure is a shielding terminal including: an inner conductor extending in an axial direction; a dielectric surrounding the inner conductor; and an outer conductor surrounding the dielectric, and the inner conductor, the dielectric, and the outer conductor are disposed in stated order from an inner side toward an outer side in a radial direction orthogonal to the axial direction, the dielectric has a cavity extending along the axial direction, the inner conductor is accommodated in the cavity, the outer conductor includes a circumferential wall covering an outer circumferential surface of the dielectric along a circumferential direction, the circumferential wall includes an opening portion extending through the circumferential wall in the radial direction, and a contact portion defined by the opening portion, the dielectric includes a hole portion extending in the radial direction from the outer circumferential surface of the dielectric to the cavity, the hole portion and the opening portion have a through-passage extending through in the radial direction at the same position in each of the axial direction and the circumferential direction, and a distal end portion of the inner conductor in the axial direction faces the through-passage of the hole portion while the inner conductor is accommodated in the cavity.

According to the present disclosure, it is possible to provide a shielding terminal that enables detecting the accommodation state of an inner conductor in a dielectric without decreasing workability of an outer conductor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shielding terminal connected to an end portion of a shielded wire in a first embodiment, as viewed obliquely from a lower rear side.

FIG. 2 is an enlarged perspective view in which a front end portion of the shielding terminal in the first embodiment is cut at a position corresponding to a hole portion and an opening portion, and a portion including the broken surface is viewed obliquely from a lower front side.

FIG. 3 is an enlarged side view of the front end portion of the shielding terminal in the first embodiment.

FIG. 4 is a perspective view showing a state in the first embodiment, in which an inner conductor of the shielding terminal is connected to a core wire of the shielded wire, and a braided wire is folded back, as viewed obliquely from the upper front side.

FIG. 5 is an enlarged side view of a front end portion of a dielectric accommodating the inner conductor provided in the shielding terminal in the first embodiment.

FIG. 6 is an enlarged cross-sectional plan view of the front end portion of the shielding terminal in the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.
(1) A shielding terminal according to the present disclosure is: a shielding terminal including: an inner conductor extending in an axial direction; a dielectric surrounding the inner conductor; and an outer conductor surrounding the dielectric, and the inner conductor, the dielectric, and the outer conductor are disposed in stated order from an inner side toward an outer side in a radial direction orthogonal to the axial direction, the dielectric has a cavity extending along the axial direction, the inner conductor is accommodated in the cavity, the outer conductor includes a circumferential wall covering an outer circumferential surface of the dielectric along a circumferential direction, the circumferential wall includes an opening portion extending through the circumferential wall in the radial direction, and a contact portion defined by the opening portion, the dielectric includes a hole portion extending in the radial direction from the outer circumferential surface of the dielectric to the cavity, the hole portion and the opening portion have a through-passage extending through in the radial direction at the same position in each of the axial direction and the circumferential direction, and a distal end portion of the inner conductor in the axial direction faces the through-passage of the hole portion while the inner conductor is accommodated in the cavity.

With the configuration of (1) above, it is possible to detect the accommodation state of the inner conductor with respect to the dielectric from the outside of the outer conductor through the through-passage. In particular, since it is possible to see the distal end portion in the axial direction of the inner conductor, the possibility of visual misrecognition can be reduced as compared with when viewing the intermediate portion in the axial direction of the inner conductor. Moreover, the opening portions are formed together with the contact portions in the circumferential wall of the outer conductor. Therefore, it is not necessary to perforate the outer conductor to separately form an opening portion to detect the accommodation state of the inner conductor, thereby preventing a decrease in workability of the outer conductor.
(2) It is preferable that wherein the contact portion has a shape extending from a base end to a distal end in a portion of the circumferential wall, the distal end of the contact portion faces an opening edge portion of the hole portion in the outer circumferential surface of the dielectric, and the opening edge portion has an inclined surface portion inclined inward in the radial direction from the base end of the contact portion toward the distal end.

With the configuration of (2) above, since the distal ends of the contact portions can move toward the inclined surface portion, it is possible to be compatible with a small shielding terminal having an outer conductor with a small diameter. Further, since the distal end of each contact portion comes into contact with the inclined surface portion, excessive elastic displacement of the contact portion can be suppressed.
(3) It is preferable that the contact portion includes a contact point located between the base end and the distal end, and an inclined portion inclined inward in the radial direction from the contact point to the distal end, and the inclined surface portion has a shape inclined along the inclined portion.

With the configuration of (3) above, since the inclined portion can extend along and come into contact with the inclined surface portion, the contact portion and the dielectric are less likely to be damaged. In addition, the shielding terminal can be reduced in size in the radial direction.
(4) In the shielding terminal according to any one of the above (1) to (3), it is preferable that, the inner conductor includes, at the distal end portion, a distal end expansion portion expanding outward in the radial direction, the dielectric has a corner portion at a position where the cavity and the hole portion intersect each other, and the distal end expansion portion protrudes from the corner portion toward the hole portion.

With the configuration of (4) above, when the accommodation state of the inner conductor with respect to the dielectric is checked, the distal end expansion portions protruding toward the hole portions can be seen, and thus visibility is excellent.
(5) In the shielding terminal according to any one of the above (1) to (4), it is preferable that, in the inner conductor has a locking portion, the dielectric has a locking hole to which the locking portion is lockable, the locking hole has a shape extending in the radial direction from the outer circumferential surface of the dielectric to the cavity, and the locking hole and the hole portion are arranged side by side at an interval in the axial direction.

With the configuration of (5) above, since the hole portions and the locking holes can be formed at the same time during molding, it is possible to prevent the structure of the molding die from becoming complicated.
(6) In the shielding terminal according to any one of the above (1) to (5), it is preferable that the hole portion extends through the dielectric in the radial direction via the cavity.

With the configuration of (6) above, it is possible to check the accommodation state of the inner conductor with respect to the dielectric from either of the openings on the two sides of the hole portion in the radial direction.

### Detailed Description of Embodiments of Present Disclosure

Specific examples of a wiring member according to the present disclosure will be described below with reference to the drawings. Note that the present invention is not limited to these examples, but rather is indicated by the scope of the claims, and is intended to include all modifications within the scope and meaning equivalent to the scope of the claims.

### first Embodiment

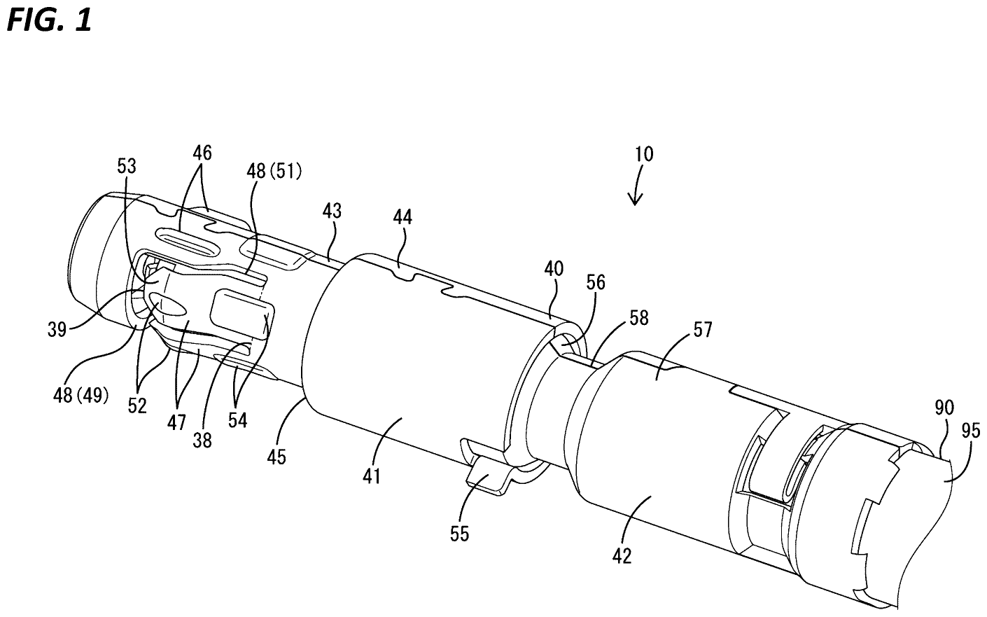

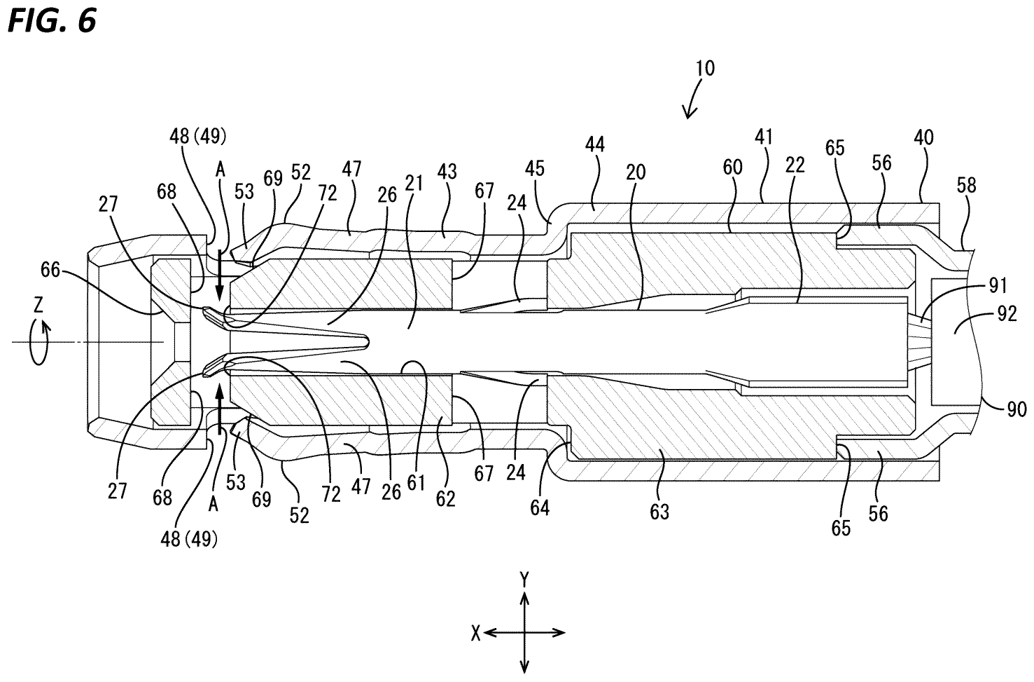

As shown in FIG. 6, a shielding terminal 10 of a first embodiment includes an inner conductor 20, an outer conductor 40, and a dielectric 60. As shown in FIG. 1, the shielding terminal 10 is connected to an end portion of a shielded wire 90. The inner conductor 20 and the outer conductor 40 are conductive and formed by pressing a metal plate. The dielectric 60 is made of an insulating material such as a synthetic resin. In the following description, with respect to the front-rear direction, the left side, which is the distal end side of the shielded wire 90 in the drawings, corresponds to the front side. The front-rear direction is synonymous with the axial direction. The direction perpendicular to the axial direction corresponds to the radial direction of the shielded wire 90. The inner side in the radial direction is a direction toward the center (axial center) of the shielding terminal 10. The outer side in the radial direction is a direction away from the center of the shielding terminal 10. In the inner conductor 20, the outer conductor 40, and the dielectric 60, a surface facing inward in the radial direction corresponds to an inner circumferential surface, and a surface facing outward in the radial direction corresponds to an outer circumferential surface. The circumferential direction is a direction along the inner circumferential surface and the outer circumferential surface. Arrows X, Y, and Z in FIG. 6 indicate the axial direction, the radial direction, and the circumferential direction, respectively. The up-down direction and the left-right direction in the drawings are the radial directions, but may be referred to as the up-down direction and the left-right direction, respectively.

### (Shielded Wire 90)

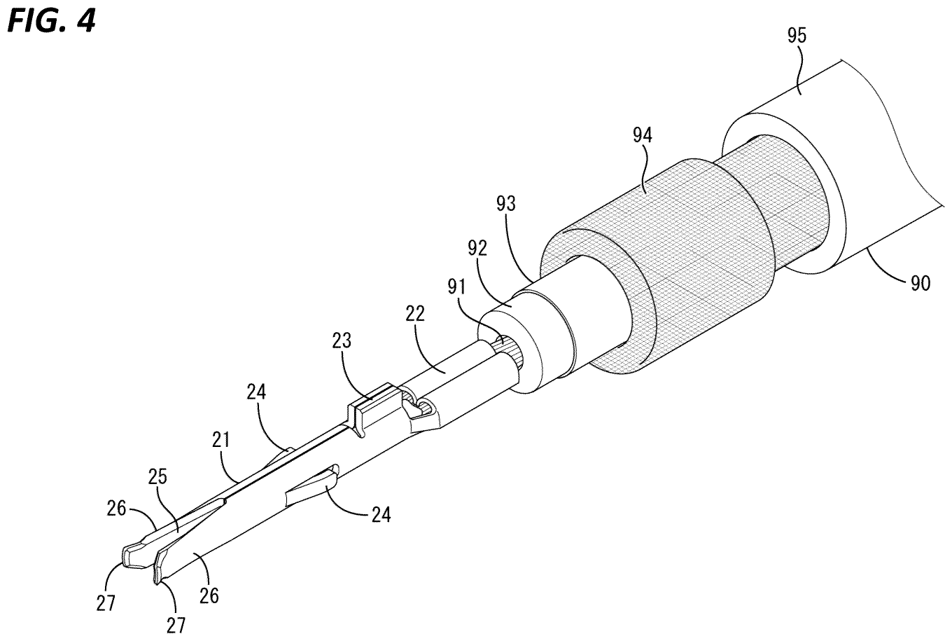

As shown in FIG. 4, the shielded wire 90 is a so-called coaxial wire in which a core wire 91, an insulating coating 92, shield members 93 and 94, and a sheath 95 are laminated in this order from the inside toward the outside in the radial direction. The shield members 93 and 94 form a shield layer that blocks electromagnetic waves. In the first embodiment, the shield members 93 and 94 are constituted by a metal foil 93 and a braided wire 94. The metal foil 93 is a copper foil or an aluminum foil wound around the outer circumferential surface of the insulating coating 92. The braided wire 94 is a conductor in which metal strands such as copper wires or aluminum wires are braided into a net shape, and is disposed on the outer circumferential side of the metal foil 93. The sheath 95 covers the outer circumferential side of the shield members 93 and 94.

At the terminal portion (front end portion) of the shielded wire 90, the sheath 95 and the insulating coating 92 are stripped and removed so that the core wire 91 and the shield members 93 and 94 are exposed. The exposed braided wire 94 is folded back to the outer circumferential side of a sleeve (a member inside the member with the reference numeral 94 in FIG. 4).

### (Inner Conductor 20)

As shown in FIG. 4, the inner conductor 20 overall has an elongated shape extending in the front-rear direction. The inner conductor 20 includes a cylindrical tube portion 21 and a barrel portion 22 having a barrel shape and continuous with the rear side of the tube portion 21. The barrel portion 22 is crimped at, and electrically and mechanically connected to a front end portion of the core wire 91.

Also, a stopper portion 23 is formed at a rear end portion of the tube portion 21. The stopper portion 23 is formed by two adjacent plate pieces rising from a partner end of the tube portion 21. The stopper portion 23 is stopped by a stopper receiving portion (not shown) of the dielectric 60 from behind.

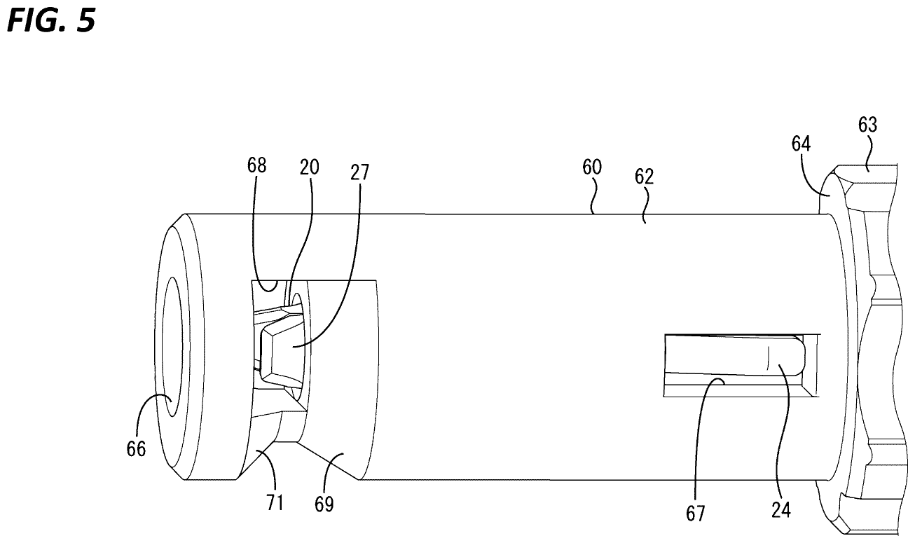

The tube portion 21 has a shape in which a pair of left and right locking portions 24 protrude outward. The locking portions 24 are formed by cutting and raising portions of the tube portion 21 radially outward. The locking portions 24 extend rearward from a front end portion, which is a base end side of a cut-and-raised portion, in a cantilevered manner, while inclining radially outward, and are elastically deformable in the radial direction using the front end portions as fulcrums. As shown in FIGS. 5 and 6, the locking portions 24 are respectively locked to inner surfaces of locking holes 67 (described later) of the outer conductor 40.

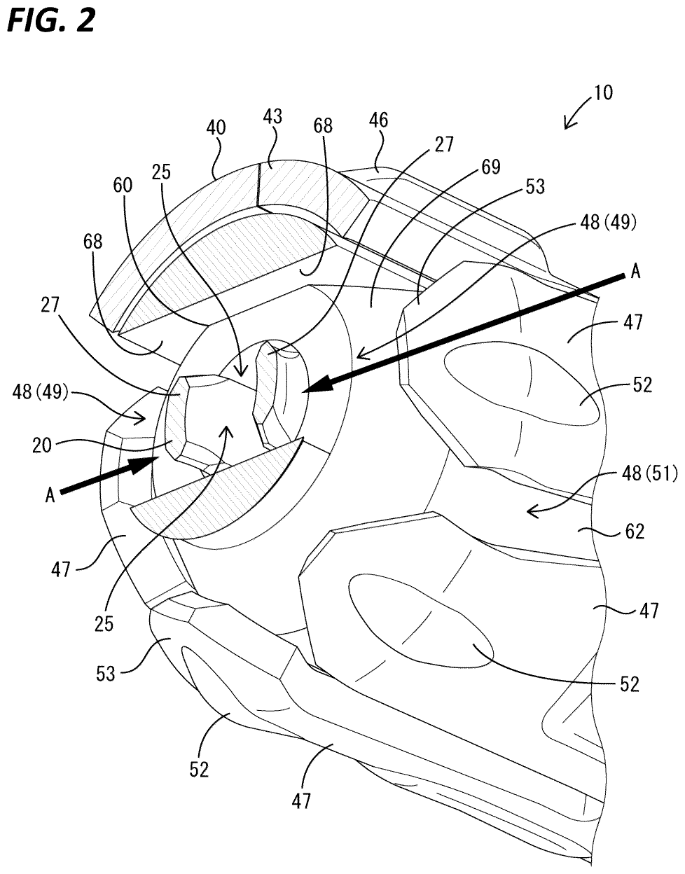

As shown in FIG. 2, a pair of upper and lower cutout portions 25 are formed at a front end portion of the tube portion 21. As shown in FIG. 4, the cutout portions 25 extend in the front-rear direction and are open at the front of the tube portion 21. A pair of left and right partner connection portions 26 are formed between the cutout portions 25 in the front end portion of the tube portion 21. The partner connection portions 26 each have a plate shape with a plate surface facing in the left-right direction (radial direction), and face each other in the left-right direction. Distal end expansion portions 27 expanding laterally outward (radially outward) are formed at a front end portion on the distal end side of the respective partner connection portions 26. The partner connection portions 26 are elastically deformable in the radial direction using a portion between back ends of each of the cutout portions 25 as a fulcrum. A partner inner conductor (not shown) is inserted into the tube portion 21 from the front by being guided into the distal end expansion portions 27. The partner inner conductor inserted into the tube portion 21 is in contact with and electrically connected to the partner connection portions 26.

### (Outer Conductor 40)

As shown in FIG. 1, the outer conductor 40 has a tubular shape and includes a front circumferential wall 41 and a rear circumferential wall 42 that are connected to each other. Both the front and rear circumferential walls 41 and 42 have a cylindrical shape and are open with its axis extending in the front-rear direction. As shown in FIG. 6, the front circumferential wall 41 includes a small-diameter portion 43, a large-diameter portion 44 whose outer diameter is larger than that of the small-diameter portion 43, and an enlarged diameter portion 45 located between the small-diameter portion 43 and the large-diameter portion 44.

The small-diameter portion 43 is disposed on the front end side of the circumferential wall 41. As shown in FIG. 1, the small-diameter portion 43 has a pair of embossed portions 46 and a plurality of contact portions 47. The embossed portions 46 and the contact portions 47 function as contact point portions that come into contact with a partner outer conductor (not shown) fitted to the circumferential wall 41 from radially inward to electrically connect the outer conductor 40 to the partner outer conductor.

The embossed portions 46 have an embossed shape and are disposed on an upper end portion of the small-diameter portion 43 at intervals in the circumferential direction. The embossed portions 46 are fixed contact point portions that are not displaced relative to the small-diameter portion 43.

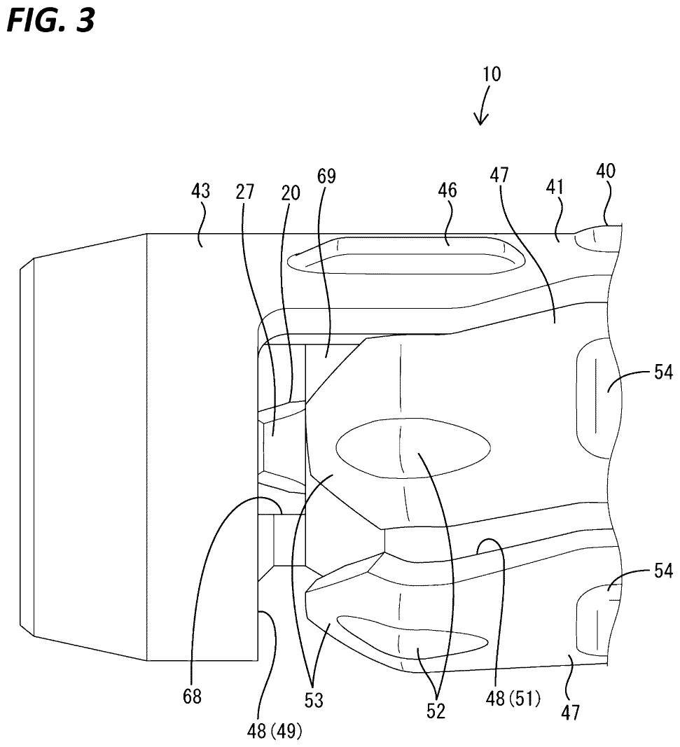

As shown in FIG. 2, the four contact portions 47 are disposed at intervals in the circumferential direction in a region of a major arc (lower region) excluding the upper end portion of the small-diameter portion 43. The contact portions 47 are movable contact point portions that are elastically deformable in the radial direction with respect to the small-diameter portion 43. As shown in FIG. 3, the contact portions 47 are formed by cutting and raising portions of the small-diameter portion 43 (circumferential wall). The contact portions 47 each extend in a cantilever manner from the base end 38 to a position of the distal end 39 that is forward of the base end 38 in a part of the small-diameter portion 43. Opening portions 48 are formed in part of the small-diameter portion 43, as the contact portions 47 are cut and raised. The opening portions 48 are slit spaces formed along outer edges of contact portions 47 in part of the small-diameter portion 43. In other words, the opening portions 48 define the outer edges of the contact portions 47. More specifically, the opening portions 48 are each formed by a front space 49 adjacent to the distal end 39 of the corresponding contact portion 47 and side spaces 51 adjacent to both circumferential ends of the contact portion 47.

A contact point 52 that can come in contact with the partner outer conductor is formed on a front end portion (portion near the distal end 39) of each of the contact portions 47 at a position protruding radially outward from the other part of the small-diameter portion 43. As shown in FIG. 6, an inclined portion 53 inclined radially inward from the contact point 52 to the distal end 39 is formed at a front end portion of each of the contact portions 47. As shown in FIG. 3, the opening width of the front spaces 49 in the front-rear direction is wider than the opening width of the side spaces 51 in the circumferential direction due to the retracted shape of the inclined portions 53. Further, as shown in FIG. 1, in the small-diameter portion 43, a reinforcing portion 54 having a flat trapezoidal shape is formed at the position overlapping the rear end portion of each of the contact portions 47. Each reinforcing portion 54 reinforces a portion of the corresponding contact portion 47 near the base end 38, which serves as a fulcrum when the contact portion 47 is elastically deformed.

As shown in FIG. 6, the enlarged diameter portion 45 is continuous with a rear end of the small-diameter portion 43 and projects radially outward in a flange shape. The large-diameter portion 44 has a cylindrical shape extending rearward from an outer circumferential end of the enlarged diameter portion 45, and is disposed on the rear end side of the circumferential wall 41. As shown in FIG. 1, a rotation suppressing portion 55 is formed on the lower end side of a rear end portion of the large-diameter portion 44. The rotation suppressing portion 55 has a flat plate shape with a plate surface facing in the circumferential direction, and is formed by cutting and raising a part of the rear end portion of the large-diameter portion 44. The rotation suppressing portion 55 is fitted into a groove portion of a housing (not shown). The outer conductor 40 is accommodated in the housing while the rotation is suppressed by the rotation suppressing portion 55.

As shown in FIG. 1, the rear circumferential wall 42 has a tubular connection portion 56, a tubular main body portion 57 located rearward of the tubular connection portion 56, and a constricted portion 58 located between the tubular main body portion 57 and the tubular connection portion 56. The tubular connection portion 56 and the tubular main body portion 57 have a cylindrical shape, and the constricted portion 58 has a constricted shape whose diameter is smaller than that of the tubular connection portion 56 and the tubular main body portion 57. The tubular main body portion 57 is fixed to the braided wire 94 of the shielded wire 90 from the radially outward side. The outer conductor 40 is electrically and mechanically connected to the braided wire 94 by the tubular main body portion 57. The constricted portion 58 is disposed so as to come into contact with the metal foil 93 (see FIG. 4) of the shielded wire 90. The tubular connection portion 56 is coaxially fitted inside the large-diameter portion 44. As shown in FIG. 6, an outer circumferential surface of the tubular connection portion 56 is disposed so as to come into contact with an inner circumferential surface of the large-diameter portion 44. The tubular connection portion 56 and the large-diameter portion 44 are coupled conductively to each other by a connection means such as spot welding.

### (Dielectric 60)

As shown in FIG. 6, the dielectric 60 is constituted by accommodating portions 62 and 63 that are integrally formed and have a cavity 61 for accommodating the inner conductor 20. The accommodating portions 62 and 63 are a front accommodating portion 62 located on the front side and a rear accommodating portion 63 located on the rear side. As shown in FIG. 5, the front accommodating portion 62 has a smaller outer diameter than that of the rear accommodating portion 63. A front end of the rear accommodating portion 63 forms a stepped surface 64 that extends in the radial direction. A radially inner reduced diameter end of the stepped surface 64 is continuous with a rear end of the front accommodating portion 62.

As shown in FIG. 6, the front accommodating portion 62 is accommodated inside the small-diameter portion 43 of the outer conductor 40. The rear accommodating portion 63 is accommodated inside the large-diameter portion 44 of the outer conductor 40. The stepped surface 64 of the accommodating portion 63 is disposed so as to come into contact with the enlarged diameter portion 45 from behind. The contact of the stepped surface 64 with the enlarged diameter portion 45 prevents the dielectric 60 from coming out forward from the outer conductor 40.

A stepped recess 65 is formed in an outer circumferential surface of the rear accommodating portion 63. The stepped recess 65 is open rearward and formed by cutting out a rear end portion of the accommodating portion 63 over the entire circumference. The tubular connection portion 56 is fitted into the stepped recess 65 of the accommodating portion 63 from behind. A front end of the tubular connection portion 56 is disposed so as to come into contact with a back end (a surface facing rearward) of the stepped recess 65 from behind. By the dielectric 60 being inserted into the tube portion 21 on the front side from behind and the tubular connection portion 56 being coupled to the large-diameter portion 44, the dielectric 60 is prevented from coming out rearward from the outer conductor 40.

As shown in FIG. 6, the cavity 61 coaxially extends through radial centers of the front and rear accommodating portions 62 and 63 in the front-rear direction and is open forward and rearward. The cavity 61 is gradually reduced in diameter from a rear end portion that is open with a large diameter dimension toward the front side in the rear accommodating portion 63, and extends with the same diameter in the front-rear direction in the front accommodating portion 62. In a front end portion of the cavity 61, a guiding portion 66 that increases in diameter toward a front surface of the accommodating portion 62 is formed. The partner inner conductor (not shown) is guided into the cavity 61 by the guiding portion 66.

As shown in FIG. 6, the dielectric 60 has locking holes 67 extending radially on opposite radial sides of the cavity 61 at a rear end of the accommodating portion 62. The locking holes 67 are open in a rectangular shape elongated in the front-rear direction at end portions on opposite radial sides of the outer circumferential surface of the rear end portion of the accommodating portion 62. The radially inner sides of the locking holes 67 are in communication with the cavity 61. In other words, the locking holes 67 extend radially from an outer circumferential surface of the accommodating portion 62 of the dielectric 60 to the cavity 61. The extending direction of the cavity 61 (front-rear direction) and the extending direction of the locking holes 67 (radial direction, left-right direction) are orthogonal to each other.

The inner conductor 20 is inserted into the cavity 61 from behind. In the process of inserting the inner conductor 20 into the cavity 61, the locking portions 24 slide on an inner circumferential surface of the cavity 61 and are elastically deformed radially inward. When the inner conductor 20 is inserted to a proper position in the cavity 61, the locking portions 24 elastically return and fit into the respective locking holes 67 from the radially inward side. As shown in FIG. 6, a rear end of each locking portion 24 is disposed so as to come into contact with a rear surface of the corresponding locking hole 67 (a surface facing forward on the rear side of the locking hole 67) from the front. Thus, the inner conductor 20 is prevented from coming out rearward from the dielectric 60. Further, the stopper portion 23 of the inner conductor 20 is stopped by a stopper receiving portion (not shown) formed on the inner circumferential surface of the cavity 61, thereby preventing the inner conductor 20 from coming out forward from the dielectric 60.

As shown in FIG. 6, the dielectric 60 has hole portions 68 extending radially on opposite radial sides of the cavity 61 at the front end portion of the accommodating portion 62. The hole portions 68 are open at opposite radial ends of the outer circumferential surface of the front end portion of the accommodating portion 62 and are in communication with the cavity 61 on the radially inner side. That is, similarly to the locking holes 67, the hole portions 68 extend radially from the outer circumferential surface of the accommodating portion 62 of the dielectric 60 to the cavity 61. The extending direction (front-rear direction) of the cavity 61 and the extending direction (radial direction, left-right direction) of the hole portions 68 are perpendicular to each other. The hole portions 68 and the locking holes 67 extend parallel to each other in the same direction. The hole portions 68 and the locking holes 67 are open side by side at an interval coaxially in the front-rear direction on the outer circumferential surface of the accommodating portion 62.

As shown in FIG. 5, an inclined surface portion 69 having a diameter gradually decreasing radially outward is formed at an opening edge portion on the rear end sides of the hole portions 68 in an outer circumferential surface of the accommodating portion 62. The inclined surface portion 69 extends obliquely downward relative to the front-rear direction (the direction along an outer circumferential surface of the dielectric 60) from an adjacent portion on the outer circumferential surface of the accommodating portion 62. As shown in FIG. 2, the inclined surface portion 69 is continuous in the circumferential direction in a portion of the outer circumferential surface of the accommodating portion 62 excluding an upper end portion, and is formed in a range of a major arc extending beyond opening edge portions of the hole portions 68. As shown in FIGS. 2, 3 and 6, the inclined portion 53 of each contact portion 47 of the outer conductor 40 is inclined radially inward and disposed to face the inclined surface portion 69 so as to come into contact therewith. Accordingly, the inclined portion 53 of each contact portion 47 can move toward the inclined surface portion 69, and prevented from being excessively elastically deformed radially inward by coming into contact with the inclined surface portion 69. Further, as shown in FIG. 5, in an opening edge portion on the front end side of each of the hole portions 68 in the outer circumferential surface of the accommodating portion 62, a facing inclined surface portion 71 inclined obliquely downward is formed on the lower end side facing the lower end side of the inclined surface portion 69.

### (Operation of Shielding Terminal 10)

In a state where the dielectric 60 is inserted into the circumferential wall 41 of the outer conductor 40, as shown in FIGS. 2, 3 and 6, the inclined portion 53 of each contact portion 47 faces the inclined surface portion 69 so as to come into contact therewith. The hole portions 68 are disposed so as to be in communication with the front spaces 49 of the respective opening portions 48. Here, as shown in FIGS. 2 and 6, the front spaces 49 of the opening portions 48 and the hole portions 68 form through-passages A extending in the radial direction at the same position (overlapping positions) in the front-rear direction (axial direction) and the circumferential direction.

In this case, when the inner conductor 20 is inserted into the cavity 61 of the dielectric 60 to a proper depth, as described above, the locking portions 24 are disposed so as to be respectively locked to inner surfaces of the locking holes 67, thereby preventing the inner conductor 20 from coming out from the cavity 61. Further, when the inner conductor 20 is inserted into the cavity 61 of the dielectric 60 to a proper depth, the distal end expansion portions 27 of the partner connection portions 26 of the inner conductor 20 enter and are disposed inside the respective hole portions 68. That is, the distal end expansion portions 27 of the inner conductor 20 face the through-passages A of the hole portions 68. Therefore, outer surfaces of the distal end expansion portions 27 of the inner conductor 20 (plate surfaces of the partner connecting portions 26 at a distal end portion of the inner conductor 20) can be visually recognized from the outside of the outer conductor 40 through the front spaces 49 of the opening portions 48 and the through-passages A of the hole portions 68. In other words, it is possible to detect (check) that the inner conductor 20 has been inserted into the cavity 61 of the dielectric 60 to a proper depth by visually recognizing the distal end expansion portions 27 of the inner conductor 20 through the through-passages A from the outside of the outer conductor 40.

On the other hand, when the inner conductor 20 has not been inserted into the cavity 61 of the dielectric 60 to a proper depth and remains at a half-inserted position, the locking portions 24 remain in an elastically deformed state while in contact with the inner circumferential surface of the cavity 61. If the locking portions 24 are not locked to the locking holes 67, the inner conductor 20 may come out of the cavity 61. However, in the first embodiment, when the inner conductor 20 is at the half-inserted position in the dielectric 60, a distal end portion of the inner conductor 20 does not reach the position of the hole portions 68, and the inner conductor 20 cannot be visually recognized from the outside of the outer conductor 40 through the front spaces 49 of the opening portions 48 and the through-passages A of the hole portions 68, respectively. Therefore, when the inner conductor 20 cannot be seen from the outside of the outer conductor 40, it can be detected that the inner conductor 20 remains at the half-inserted position in the dielectric 60. If the inner conductor 20 cannot be visually recognized in this way, the inner conductor 20 is pushed to a proper position in the cavity 61. This makes it possible for the distal end portions of the inner conductors 20 to be seen through the hole portion 68, and the inner conductors 20 are prevented from coming out from the cavity 61.

Further, in the first embodiment, the distal end expansion portions 27 can enter the hole portion 68 after sliding on a corner portion 72 (see FIG. 6) formed at an intersection between the cavity 61 and the hole portion 68 by obtaining a reaction force applied when the partner connection portions 26 elastically return. Therefore, a situation can be prevented in which the inner conductor 20 remains at the half-inserted position with respect to the dielectric 60. Furthermore, the accommodation state of the inner conductor 20 in the dielectric 60 can be detected through the through-passages A from the openings on both left and right sides (both upper and lower sides in FIG. 6) of the outer conductor 40.

As described above, the shielding terminal 10 of the first embodiment includes the inner conductor 20 extending in the front-rear direction (axial direction), the dielectric 60 surrounding the inner conductor 20, and the outer conductor 40 surrounding the dielectric 60. The inner conductor 20, the dielectric 60, and the outer conductor 40 are arranged in this order from the inner side toward the outer side in the radial direction that is perpendicular to the front-rear direction. The dielectric 60 includes the cavity 61 extending along the front-rear direction. The inner conductor 20 is accommodated in the cavity 61. The outer conductor 40 has a circumferential wall 41 that covers the outer circumferential surface of the dielectric 60 along the circumferential direction. The circumferential wall 41 has the opening portions 48 that extend radially through the circumferential wall 41, and the contact portions 47 defined by the opening portions 48. The dielectric 60 further has the hole portions 68 extending radially from the outer circumferential surface of the dielectric 60 to the cavity 61. The hole portions 68 and the opening portions 48 respectively have the through-passages A that extend in the radial direction, at the same position in the front-rear direction and the circumferential direction. The front end portion of the inner conductor 20 (distal end portion in the axis direction) faces the through-passages A of the hole portions 68 while the front end portion of the inner conductor 20 is accommodated in the cavity 61.

According to the above configuration, it is possible to detect the accommodation state of the inner conductor 20 with respect to the dielectric 60 from the outside of the outer conductor 40 through the through-passages A. In particular, since it is possible to see the distal end portion of the inner conductor 20, the possibility of visual misrecognition can be reduced as compared with the case of viewing the intermediate portion of the inner conductor 20. Moreover, the contact portions 47 are formed together with the opening portions 48 in the circumferential wall 41 of the outer conductor 40. Therefore, it is not necessary to perforate the outer conductor 40 to separately form the opening portions 48 to detect the accommodation state of the inner conductor 20, thereby preventing a decrease in workability of the outer conductor 40.

In the shielding terminal 10 of the first embodiment, the contact portions 47 each have a shape extending from the base end 38 to the distal end 39 in a part of the circumferential wall 41. The distal end 39 of each contact portion 47 faces an opening edge portion of the hole portion 68 on the outer circumferential surface of the dielectric 60. An opening edge portion of each hole portion 68 has an inclined surface portion 69 that is inclined radially inward from the base end 38 toward the distal end 39 of the contact portion 47. According to this configuration, since the distal ends 39 of the contact portions 47 can move toward the inclined surface portion 69, it is possible to be compatible with a small shielding terminal 10 having an outer conductor 40 with a small diameter. Further, since the distal end 39 of each contact portion 47 comes into contact with the inclined surface portion 69, excessive elastic displacement of the contact portion 47 can be suppressed.

Further, the contact portions 47 each have the contact point 52 located between the base end 38 and the distal end 39, and the inclined portion 53 inclined radially inward from the contact point 52 to the distal end 39. Each inclined surface portion 69 has a shape inclined along the inclined portion 53. According to this configuration, since each inclined portion 53 can extend along and come into contact with the inclined surface portion 69, the contact portions 47 and the dielectric 60 are less likely to be damaged. In addition, the shielding terminal 10 can be reduced in size in the radial direction.

In the shielding terminal 10 of the first embodiment, the inner conductor 20 has the distal end expansion portions 27 expanding radially outward at the distal end portion in the front-rear direction. The dielectric 60 has a corner portion 72 at a position where the cavity 61 and the hole portion 68 intersect each other. The distal end expansion portions 27 protrude from the corner portion 72 toward the hole portion 68. According to this configuration, when the accommodated state of the inner conductor 20 with respect to the dielectric 60 is checked, it is only necessary to view the distal end expansion portions 27 protruding toward the hole portion 68, and therefore excellent visibility is achieved.

In the shielding terminal 10 of the first embodiment, the inner conductor 20 has the locking portions 24. The dielectric 60 has the locking holes 67 to which the locking portions 24 can be locked. The locking holes 67 each have a shape extending in the radial direction from the outer circumferential surface of the dielectric 60 to the cavity 61. The locking holes 67 and the hole portions 68 are arranged side by side at an interval in the front-rear direction. According to this configuration, since the hole portions 68 and the locking holes 67 can be formed at the same time during molding, it is possible to prevent the structure of the molding die from becoming complicated.

Further, in the shielding terminal 10 of the first embodiment, the hole portions 68 extend radially through the dielectric 60 via the cavity 61. According to this configuration, it is possible to detect the accommodation state of the inner conductor 20 with respect to the dielectric 60 from either of the openings on the two sides of the hole portion in the radial direction, and reliability of the detection can be improved.

### Other Embodiments of Present Disclosure

The first embodiment disclosed here is to be considered in all respects as illustrative and not limiting.

In the first embodiment, the dielectric accommodates one inner conductor. In contrast to this, according to the other embodiment, the dielectric may accommodate two or more inner conductors. For example, if the dielectric accommodates two inner conductors, unlike the first embodiment, the inner conductor, the dielectric, and the outer conductor do not need to be formed concentrically.

In the first embodiment, a mark for detection is not particularly applied to a distal end portion (distal end expansion portion) of an inner conductor to be visually recognized in detection. Unlike this, in another embodiment, a mark for detection may be formed on a portion to be visually recognized, such as the distal end portion of the inner conductor, and may be, for example, colored in a specific color that can be specified.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielding terminal comprising:
an inner conductor extending in an axial direction;
a dielectric surrounding the inner conductor; and
an outer conductor surrounding the dielectric,
wherein the inner conductor, the dielectric, and the outer conductor are disposed in stated order from an inner side toward an outer side in a radial direction orthogonal to the axial direction,
the dielectric has a cavity extending along the axial direction,
the inner conductor is accommodated in the cavity,
the outer conductor includes a circumferential wall covering an outer circumferential surface of the dielectric along a circumferential direction,
the circumferential wall includes an opening portion extending through the circumferential wall in the radial direction, and a contact portion defined by the opening portion,
the dielectric includes a hole portion extending in the radial direction from the outer circumferential surface of the dielectric to the cavity,
the hole portion and the opening portion have a through-passage extending through in the radial direction at the same position in each of the axial direction and the circumferential direction, and
a distal end portion of the inner conductor in the axial direction faces the through-passage of the hole portion while the inner conductor is accommodated in the cavity.

2. The shielding terminal according to claim 1,
wherein the contact portion has a shape extending from a base end to a distal end in a portion of the circumferential wall,
the distal end of the contact portion faces an opening edge portion of the hole portion in the outer circumferential surface of the dielectric, and
the opening edge portion has an inclined surface portion inclined inward in the radial direction from the base end of the contact portion toward the distal end.

3. The shielding terminal according to claim 2,
wherein the contact portion includes a contact point located between the base end and the distal end, and an inclined portion inclined inward in the radial direction from the contact point to the distal end, and
the inclined surface portion has a shape inclined along the inclined portion.

4. The shielding terminal according to claim 1,
wherein the inner conductor includes, at the distal end portion, a distal end expansion portion expanding outward in the radial direction,
the dielectric has a corner portion at a position where the cavity and the hole portion intersect each other, and
the distal end expansion portion protrudes from the corner portion toward the hole portion.

5. The shielding terminal according to claim 1,
wherein the inner conductor has a locking portion,
the dielectric has a locking hole to which the locking portion is lockable,
the locking hole has a shape extending in the radial direction from the outer circumferential surface of the dielectric to the cavity, and
the locking hole and the hole portion are arranged side by side at an interval in the axial direction.

6. The shielding terminal according to claim 1,
wherein the hole portion extends through the dielectric in the radial direction via the cavity.
